(19) United States
(12) Patent Application Publication
(10) Pub. No.: US 2007/0119027 A1
(43) Pub. Date: May 31, 2007

(54) Foldable and rotatable mobile phone with positioning mechanism

(76) Inventors: Ching Chang Wang, Tucheng City (TW); Chih Yu Chen, Tucheng City (TW); Shao Guang Fang, Tucheng City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/436,578

(22) Filed: May 19, 2006

(30) Foreign Application Priority Data
Nov. 25, 2005 (TW) 094220522

(51) Int. Cl. E05D 3/10

(52) U.S. Cl. 16/367; 128/206.19; 16/303

(57) ABSTRACT

A foldable and rotatable mobile phone with positioning mechanism includes a cover, a body, and a hinge unit rotationally coupling the cover and the body about a first axis for unfolding the cover and a second axis perpendicular to the first axis for rotating the cover. The cover defines a positioning hole. The hinge unit defines an opening corresponding to the positioning hole. The positioning mechanism includes a cantilevered arm disposed in the hinge unit. One end of the cantilevered arm connects to the hinge unit, while the other end is free and forms a protuberance thereon. The protuberance extends above the top surface of the hinge unit through the opening and is depressible within the opening to enable the protuberance to be inserted into the positioning hole for positioning the cover or release from the positioning hole for permitting the cover rotation.

### BACKGROUND OF THE INVENTION

1. Field of the Invention

The present invention relates to a mobile phone, and more particularly to a foldable and rotatable mobile phone with positioning mechanism.

2. The Related Art

Two way communication device, such as pagers and foldable mobile phones, are increasingly utilizing two foldable housing assemblies for compactness. The housing assemblies are usually referred to as a body and a cover. In most instances, the body includes a keypad and the bulk of electronics for receiving and transmitting messages from a remote transmission station. A small portion of electronics and a display is located in the cover of the foldable mobile phone. The cover and the body are connected with hinging mechanism. The display and the keypad face each other and enclose them on the inside of the foldable mobile phone when mobile phones are in a fold position. When use the mobile phone, a user lifts the cover up to be an unfolded position

Recently, a mobile phone having a camera for image communication has been developed. In such mobile phone, the camera is embedded in the body or the cover, or detachably mounted at the hinging mechanism. In order to take pictures in all directions, the camera embedded together with the body or the flip cover or the hinging mechanism should be able to be turned to all directions while ensuring the display always faces the user to enable the user to identify whether the camera takes pictures normally. Under such requirement, a mobile phone, of which the cover can perform rotating operation besides unfolding or opening and closing operation relative to the body, has been developed. However, there is a problem in that when the cover is unfolded, the cover maybe unintentionally rotates to an undesired direction.

### SUMMARY OF THE INVENTION

Accordingly, an object of the present invention is to provide a foldable and rotatable mobile phone with positioning mechanism which is capable of positioning a cover of the mobile phone when the cover should not rotate in an unfolded position and release the cover when rotate the cover intentionally, thereby preventing unintentional rotation of the cover.

In order to fulfill the object above, the present invention provides a foldable and rotatable mobile phone, which includes a cover, a body, a hinge unit rotationally coupling the cover and the body about a first axis for unfolding the cover and about a second axis perpendicular to the first axis for rotating the cover, and a positioning mechanism for positioning the cover in unfolded positions. The cover has a bottom surface. A positioning hole is defined in the bottom surface of the cover. The hinge unit has a top surface. An opening is defined in the top surface corresponding to the positioning hole. The positioning mechanism includes a cantilevered arm disposed in the hinge unit. One end of the cantilevered arm connects to the hinge unit, while the other end is free and forms a protuberance thereon. The protuberance extends above the top surface of the hinge unit through the opening and is depressible within the opening. In use, the protuberance is inserted into the positioning hole for positioning the cover or release from the positioning hole for permitting the cover rotation.

When the cover is desired to be kept in unfolded positions without rotation, the protuberance is inserted into the positioning hole of the cover to prevent the cover from rotating. While the cover rotates, the protuberance is depressed by the cover and then released from the positioning hole to permit the cover to rotate. Therefore, unintentional rotation of the cover is avoided.

### BRIEF DESCRIPTION OF THE DRAWINGS

The present invention will be apparent to those skilled in the art by reading the following description of preferred embodiments thereof, with reference to the attached drawings, wherein:

FIG. 1 is a perspective view of a foldable and rotatable mobile phone with positioning mechanism according to the present invention, in which a cover of the mobile phone is in an unfolded position;

FIG. 2 is a perspective view of the cover of the foldable and rotatable mobile phone shown in FIG. 1;

FIG. 3 is a perspective view of a hinge unit of the foldable and rotatable mobile phone shown in FIG. 1;

FIGS. 4A and 4C are cross-sectional views of the hinge unit shown in FIG.3;

FIG. 4B is a partially enlarged view of the encircled portion labeled 4B of FIG. 4A;

FIG. 5 is a perspective view C of a positioning mechanism of the foldable and rotatable mobile phone;

FIG. 6A is a cross-sectional view showing the positioning mechanism of the first embodiment mounted in the hinge unit;

FIG. 6B is a partially enlarged view of the encircled portion labeled 6B of FIG. 6A;

FIG. 7 is a perspective view of the first embodiment of the foldable and rotatable mobile phone showing the rotation of the cover;

FIG. 8A is a perspective view of a second embodiment of a positioning mechanism of the foldable and rotatable mobile phone;

FIG. 8B is a cross-sectional view of FIG. 8A; and

FIG. 9 is a perspective view of the second embodiment of the foldable and rotatable mobile phone showing the rotation of the cover.

### DETAILED DESCRIPTION OF THE PREFERRED EMBODIMENTS

For facilitating understanding, like components are designated by like reference numerals throughout the various embodiments of the invention as shown in the attached drawings.

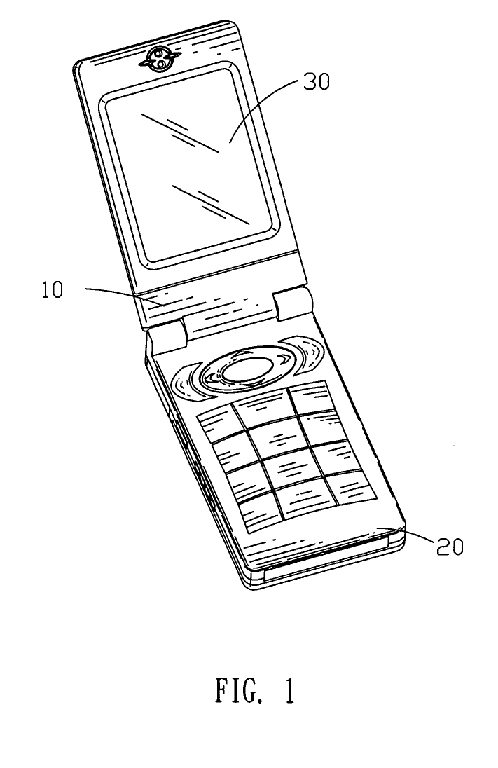

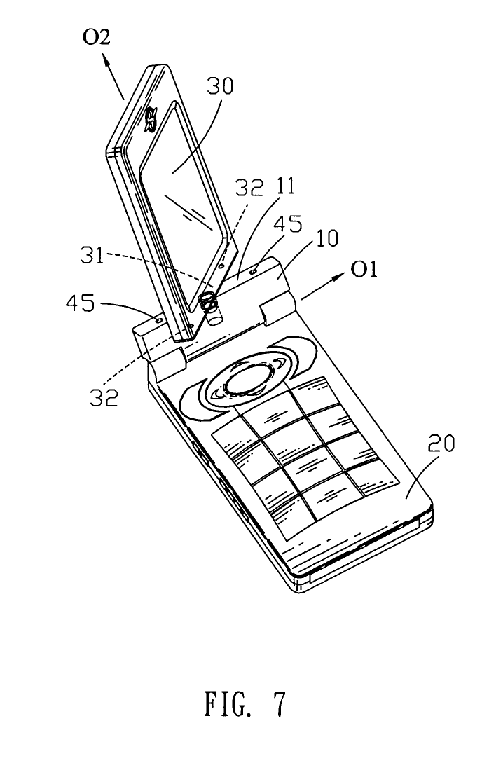

With reference to FIGS. 1-7, a first embodiment of a foldable and rotatable mobile phone according to the present invention is shown. The mobile phone includes a hinge unit 10, a body 20, a cover 30, and a positioning mechanism 40. The hinge unit 10 rotationally couples the cover 30 and the body 20 by a first axis O₁ for unfolding the cover 30 as seen in FIG. 1 and a second axis O₂ perpendicular to the first axis O₁ for rotating the cover 30 as seen in FIG. 7. Since the rotation structure and rotation function of the hinge unit 10 is well known to those skilled in the art, a detailed description thereof is omitted herein except new structures designed thereon in the present invention as described hereinafter. The positioning mechanism 40 is disposed between the cover 30 and the hinge unit 10 for positioning the cover 30 in unfolded positions without rotation (as shown in FIG. 1) as will be described in greater detail hereinafter.

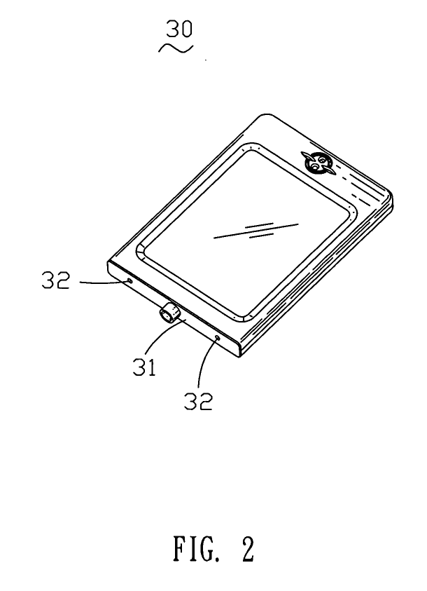

As shown in FIG. 2, the cover 30 has a bottom surface 31. A pair of positioning holes 32 is defined in the bottom surface 31.

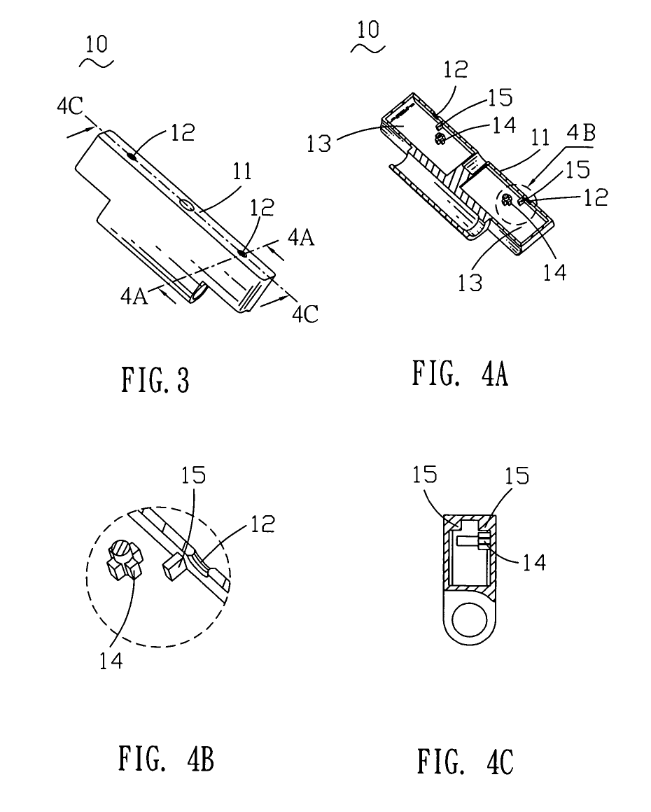

Please refer to FIG. 3 in conjunction with FIGS. 1 and 7. The hinge unit 10 has a top surface 11. In the assembly, the bottom surface 31 of the cover 30 is overlapped on the top surface 11 of the hinge unit 10 as shown in FIG. 1. Once the cover 30 is rotated around the second axis O₂, the bottom surface 31 and the top surface 11 are staggered. A pair of openings 12 is defined in the top surface 11 corresponding to the pair of positioning holes 32 of the cover 30.

FIGS. 4A-4C show a detailed inner structure of the hinge unit 10. A receiving space 13 is formed in the hinge unit 10. The receiving space 13 opens to the top surface 11 through the openings 12. A pair of fixing bolts 14 are disposed in the receiving space 13 beside each opening 12. Adjacent to each opening 12, a pair of restricting blocks 15 are provided with a predetermined space there-between.

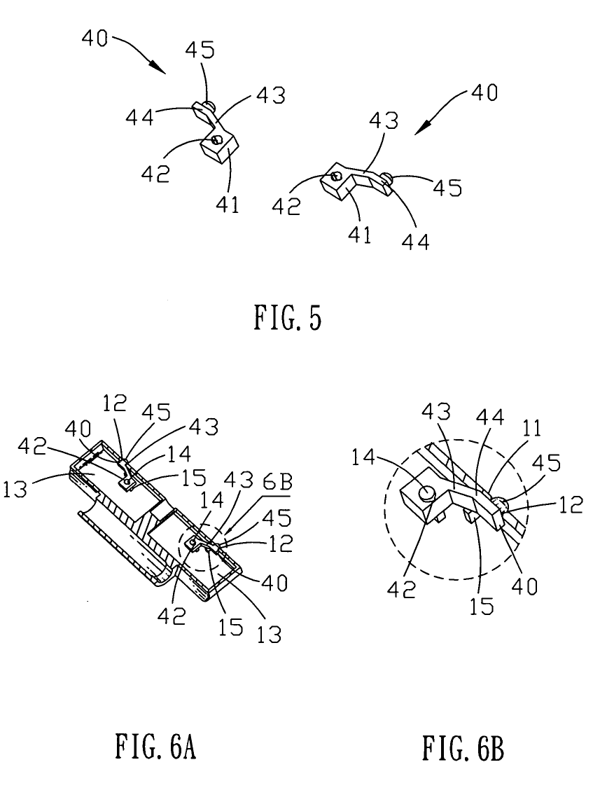

FIG. 5 shows the positioning mechanism 40 including two cantilevered arms 43. Each cantilevered arm 43 has a first end 41 and an opposite second end 44. The first end 41 defines a fixing hole 42 extending there-through. The second end 44 forms a protuberance 45 thereon. Referring to FIGS. 6A and 6B, the fixing bolt 14 is inserted into the fixing hole 42 so that the first end 41 of the cantilevered arm 43 is connected to the hinge unit 10 while leaving the second end 44 free. The protuberance 45 extends above the top surface 11 of the hinge unit 10 through the opening 12. Since the second end 44 is free, the protuberance 45 is depressible within the opening 12. The space between the pair of restricting blocks 15 is about the width the second end 44 in order to receive the second end 44 there-between. So the second end 44 is only allowed to move upward and downward and prohibited to move sideward. In this way, the pair of restricting blocks 15 guides the protuberance 45 aligning to the opening 12 all the way.

FIGS. 1 and 7 are perspective views of the foldable and rotatable mobile phone. Prior to assembly of the cover 30 and the body 20, the positioning mechanism 40 is disposed into the hinge unit 10 as described above. Thereafter, the bottom side of the hinge unit 10 connects to the body 20, and the opposite top side of the hinge unit 10 connects to the cover 30. After the cover 30 is connected to the hinge unit 10, the cover 30 is rotatable around the second axis O₂. During the rotation, the protuberance 45 is pressed downward by the bottom surface 31 of the cover 30 until it is approximately flush with the top surface 11 of the hinge unit 10. Then the protuberance 45 is maintained depressed and the second end 44 of the cantilevered arm 43 generates a compression force. Once the protuberance 45 is aligned to the positioning hole 32, a resilient force of the second end 44 of the cantilevered arm 43 urges the protuberance 45 to be inserted into the positioning hole 32 of the cover 30. Thus the cover 30 is positioned and can be kept in unfolded positions without rotation. Unintentional rotation of the cover 30 is avoided. When the cover 30 is desired to be rotated, rotates the cover 30 manually, and the protuberance 45 is depressed within the opening 12 again. The protuberance 45 releases from the positioning hole 32. So the cover 30 is allowed to rotate.

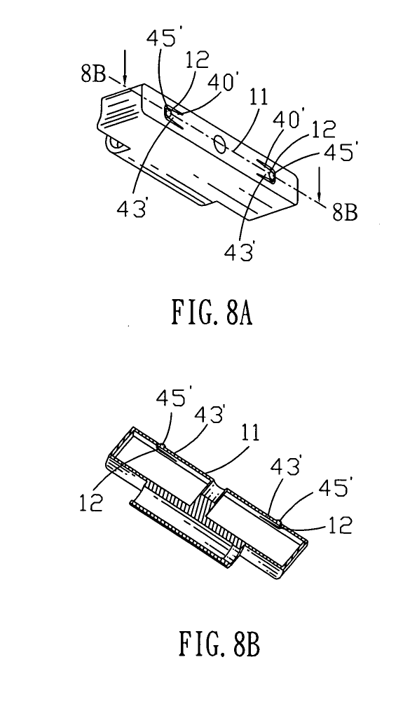

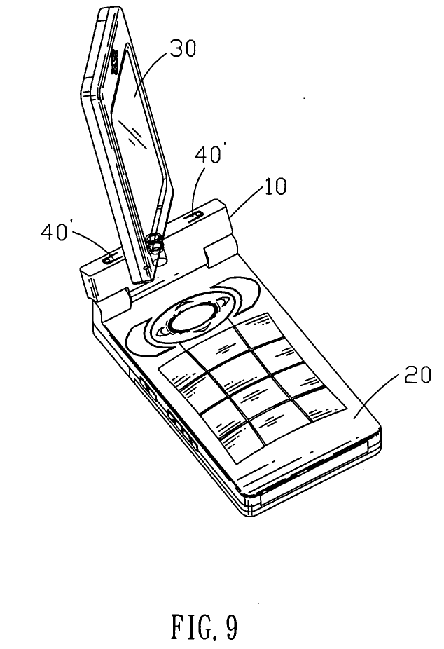

With reference to FIGS. 8A, 8B and 9, a second embodiment of the foldable and rotatable mobile phone is shown. The foldable and rotatable mobile phone in the second embodiment is similar to that shown in the first embodiment. The difference between the first embodiment and the second embodiment is only in the positioning mechanism 40′. The positioning mechanism 40′ includes a pair of cantilevered arms 43′. Each cantilevered arm 43′ is an integrally molded portion of the hinge unit 10. The free end of the cantilevered arm 43′ forms a protuberance 45′ thereon and extends to the opening 12. The protuberance 45′ projects above the top surface 11 of the hinge unit 10.

The foregoing description of the present invention has been presented for purposes of illustration and description. It is not intended to be exhaustive or to limit the invention to the precise form disclosed, and obviously many modifications and variations are possible in light of the above teaching. Such modifications and variations that may be apparent to those skilled in the art are intended to be included within the scope of this invention as defined by the accompanying claims.

What is claimed is:

1. A foldable and rotatable mobile phone with positioning mechanism comprising:
a cover having a bottom surface, a positioning hole being defined in the bottom surface;
a body;
a hinge unit rotationally coupling the cover and the body about a first axis for unfolding the cover and a second axis perpendicular to the first axis for rotating the cover, the hinge unit having a top surface, an opening being defined in the top surface corresponding to the positioning hole; and
a positioning mechanism comprising a cantilevered arm disposed in the hinge unit, one end of the cantilevered arm connecting to the hinge unit, the other end of the cantilevered arm being free and forming a protuberance thereon, the protuberance extending above the top surface of the hinge unit through the opening and being depressible within the opening to enable the protuberance to releasably insert into the positioning hole.

2. The foldable and rotatable mobile phone with positioning mechanism as claimed in claim 1, wherein the hinge unit forms a fixing bolt beside the opening, the connected end of the cantilevered arm defining a fixing hole, the cantilevered arm connected to the hinge unit by the fixing bolt inserting into the fixing hole.

3. The foldable and rotatable mobile phone with positioning mechanism as claimed in claim 2, wherein the hinge unit further forms a pair of restricting blocks adjacent to the opening between which the free end of the cantilevered arm is received for guiding the protuberance aligning to the opening.

4. The foldable and rotatable mobile phone with positioning mechanism as claimed in claim 1, wherein the cantilevered arm is an integrally molded portion of the hinge unit.
